(19) United States
(12) Patent Application Publication
(10) Pub. No.: US 2008/0090560 A1
(43) Pub. Date: Apr. 17, 2008

(54) Method and Apparatus for Accessing a Service

(75) Inventors: Makram Bouzid, Palaiseau (FR); Patricia M. Charlton, London (GB); Myriam Ribiere, Nozay (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/577,275

(22) PCT Filed: Nov. 4, 2005
(86) PCT No.: PCT/US05/40074

§ 371 Date: Apr. 13, 2007

(30) Foreign Application Priority Data
Nov. 22, 2004 (GB) 0425629.3

(51) Int. Cl. H04M 3/42

(52) U.S. Cl. 455/416

(57) ABSTRACT

An access unit (107) detects a service access (201) suitable for group operation and in response transmits (203) a group formation request to a plurality of applications. The applications decide whether to join the group (205) and the access unit (107) receives a group join indication from the applications deciding to join (207). Each group join indication comprises application constraint data in response to which the access unit (107) determines group constraint data (209) indicative of the constraints of the group of applications. The access unit (107) then accesses (211) a service using the group constraint data. The access unit subsequently receives service data (213) which is forwarded (215) to the individual applications. The invention may provide group based services based on services and/or applications designed for single users.

### FIELD OF THE INVENTION

The invention relates to a method and apparatus for accessing a service and in particular, but not exclusively, for providing a group service by accessing a single user service.

### BACKGROUND OF THE INVENTION

In recent years, the means, services and desires for electronic information exchange has increased rapidly. This has resulted in the emergence of a large number of new services and communication means including for example email chat and SMS (Short Messaging Services).

In addition, the emergence and adoption of personal computers and the Internet has lead to many new services and applications based on data communications being developed and introduced. Such services and applications include for example personal information managers, online ticket reservations, online games etc.

The current services and applications tend to be user centric providing functionality for individual users. Thus, typically a service or application is designed for meeting the needs of an individual user rather than a group of users.

In addition, some services and applications have been developed which seek to provide group services, for example by allowing information to be shared between a group of users. However, current group based applications tend to be relatively static and rely on static assumptions about the group behaviour and characteristics. For example, shared software applications have been implemented wherein software applications running on different personal computers may exchange information to provide users with information relating to a group of users. E.g. shared calendar applications have been developed which exchange diary information in order to allow each application to present a diary for all users of a group. Such calendar applications may for example be used for scheduling meetings at a time which is convenient for all involved. However, current shared software applications tend to be specifically designed to provide group functionality. Thus, the functionality required for supporting group applications are included during the design stage rather than at run time.

Thus, whereas such applications and services may provide group based services, they tend to be inflexible and cannot easily be modified or adapted to new scenarios. Furthermore, the approach requires that all services and applications are designed to be compatible with the specific protocols and algorithms used to provide the group functionality. Also, the group functionality is specified at the design stage and cannot be modified and adapted at run time.

Hence, most current group based applications and services have been designed from the service perspective and are application specific solutions which solve specific problems using a predefined group based sharing of information. Consequently, these solutions are generally not reusable for other applications and cannot be modified dynamically at run time. Furthermore, the services and applications can only interoperate if they are designed to be compatible with the predefined group functionality and protocols.

In particular, interoperability requires both services and applications to have been designed to provide group functionality in accordance with the same protocols.

This may be disadvantageous in many situations. For example, a service which has been designed for a single user cannot be used to provide a group based service. Thus, e.g. a ticket reservation system for individual users cannot be modified at run time to provide for group based ticket reservation rather than individual user ticket reservation.

Hence, an improved system for accessing a service would be advantageous and in particular a system allowing for increased flexibility, improved performance and/or enhanced group functionality would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a method of accessing a service, the method comprising: transmitting a group formation request to a plurality of applications; receiving a group join indication from at least some applications of the plurality of applications, the group join indication of each application of the at least some applications comprising application constraint data; determining group constraint data in response to the application constraint data of each of the at least some applications; and accessing the service using the group constraint data.

The invention may allow for improved group based services. In particular, a more flexible application of services to groups of users may be provided and/or service access by group based applications may be enabled, improved and/or facilitated. For example, a single user service may be used in a group context.

A group may be formed dynamically at run time and group constraint data may dynamically be determined in response to application constraint data of individual applications.

The group constraint data may be indicative of a combined constraint of the group of applications. For example, a reservation system suitable for a single user may be accessed by a group of users by generating group constraint data which is indicative of the constraints of all users.

The accessing of the service may be an access comparable to a single user access but using group constraint data rather than individual user constraint data. The group based service access may be indistinguishable from a single user access. Hence, the invention may allow a single user service to be adapted to a group based service. This adaptation may be dynamically done at run time and does not necessitate any modifications of the service or the applications.

According to an optional feature of the invention, the method further comprises receiving service output data from the service and distributing the service output data to the at least some applications.

This may facilitate, enable and/or enhance group based service access. The feature may in particular allow single applications to interact with a single user service while obtaining group functionality and group based services.

According to an optional feature of the invention, the service has at least one associated service input and the group constraint data comprises constraint data for the associated service input.

The at least one associated service input may be a data input requirement for the service. For example, the at least one associated service input may be an input identifying a time interval. The constraint data for the associated service input may indicate a constraint for a parameter for the service which is provided using the associated service input. For example, the constraint data may indicate a time interval required by the service. The time interval may be determined in response to application constraint data from the at least some applications. This may facilitate the use of group based constraint data as an input to a service.

According to an optional feature of the invention, the group formation request comprises an indication of a characteristic of the associated service input. This may facilitate group formation and the determination of suitable group constraint data. In particular, it may provide for a low complexity communication of information allowing the individual applications to customise operation and/or data for the specific service.

According to an optional feature of the invention, the at least some applications determine the application constraint data in response to the associated service input and user data of the application.

This may provide for facilitated operation and/or increased group functionality and/or performance. For example, for an event reservation service, the user data of the application may comprise a diary entry indicating that the user is not available. For an associated service input requiring a time of availability to be provided, the application constraint data for the associated service input may indicate that the time interval of the diary entry should be excluded.

According to an optional feature of the invention, the determining of the group constraint data comprises determining a group constraint data value for the associated service input in response to application constraint data of the at least some applications for the associated service input.

This may provide for facilitated operation and/or increased group functionality and/or performance. For example, group constraint data for the associated service input which excludes all time intervals excluded by one or more of the applications may be derived Accordingly, the service may be accessed with group constraint data for the associated service input which indicates all time intervals in which not all users are available. The format of the group constraint data may be compatible with the application constraint data and in particular the data structures may be substantially identical. Thus, in embodiments wherein the associated service input is designed for receiving application constraint data input from a single user, the service and the service input may still be used to provide a group based service to a group of applications. Indeed, the group based service may e.g. be provided even if the applications are alternatively or additionally designed as single user applications.

According to an optional feature of the invention, the group constraint data is determined by combining the application constraint data of the at least some applications. This provides an effective and low complexity determination of group constraint data which may be suitable for many services. For example, the combination may generate group constraint data which comprises all the constraints included in the application constraint data of all the individual applications.

According to an optional feature of the invention, the method further comprises determining a group context associated with the service. The group context may for example comprise an indication of the type of service, an indication of applications (or users) associated with the group and a set of characteristics associated with the group such as a set of rules or criterions for determining group constraint data. This may facilitate setting up group services and may in particular assist the formation of a group based on predetermined or stored information.

According to an optional feature of the invention, the group formation request comprises the group context information. This may facilitate and/or enhance the operation of the applications and may allow applications to adapt functionality or data to the characteristics of the group context information.

According to an optional feature of the invention, the method comprises selecting the plurality of applications in response to the group context. This may facilitate and/or improve group formation. For example, the group context may comprise an indication of users previously interested in the service and the group formation request may be sent to these.

According to an optional feature of the invention, the group constraint data is further determined in response to the group context. this may facilitate and/or improve the determination of the group context information. For example, the group constraint data may be determined in accordance with criteria and rules comprised in the group context. In particular, criteria for determining group constraint data may be based on or directly obtained from a stored group context. This may for example allow a consistent determination of group constraint data and/or may allow previously derived rules to be used for future service accesses.

According to an optional feature of the invention, the determination of the group context comprises retrieving a stored group context associated with the service. This may facilitate and/or improve a group based service access. In particular it may allow a group context to be quickly and easily derived. For example, when a group service setup is initiated for a service, desired characteristics of the group, such as an identification of potential group members, may be quickly identified by retrieving a predetermined group context. The stored group context may have been derived in response to previous group based service accesses.

According to an optional feature of the invention, the method further comprises updating a group context in response to a characteristic of the access of the service; and storing the updated group context. This may allow for a learning approach to determining a suitable group formation and service access. For example, characteristics associated with previous group accesses may be used to determine a group context which may be used for a current or future service access. E.g. the group context may be updated to include any new users who joined the group thereby allowing for these to receive a group formation request when the group context is initiated for a new service access.

According to an optional feature of the invention, the method further comprises determining a service context of the service and transmitting the group formation request is dependent on the service context. The service context may for example comprise an indication of the purpose, required inputs, provided outputs and operation of the service. This may facilitate detection of a service which may advantageously be used for a group based access. The service context may for example be determined when a user accesses a service as a single user. For example, it may be detected if the service context matches a predefined service (e.g. that a service accessed by a user is an event reservation service for an event of interest to other users), and if so the group formation requests may be transmitted.

According to an optional feature of the invention, each of the plurality of applications determines whether to join the group in response to a user preference associated with the application. This may improve the flexibility and/or performance of a group based service access. In particular, an improved user experience may be provided to users of the applications. The feature may e.g. allow applications to join groups having preferred characteristics while not joining groups which do not have these preferred characteristics. The user preference may for example be a user preference for a certain event causing the application to join e.g. an event reservation service if the event corresponds to the preferred event.

According to an optional feature of the invention, each of the plurality of applications determines whether to join the group in response to a service characteristic of the service. This may improve the flexibility and/or performance of a group based service access. In particular, an improved user experience may be provided to users of the applications. The feature may e.g. allow applications to join groups related to services having preferred characteristics while not joining groups which do not have these preferred characteristics. The service characteristic may for example comprise an indication of the type of service. Each of the plurality of applications may determine whether to join the group in response to a comparison of the service characteristic and a user preference associated with the application.

According to an optional feature of the invention, the service characteristic is an input requirement of the service. This may for example allow applications to only join groups for a service with which it can provide the required data.

According to an optional feature of the invention, the method further comprises determining a group profile comprising the group constraint data, an identification of the at least some applications and an identification of the service. The service may be accessed using the group profile. The group profile may be communicated to the applications. This may allow for improved performance and may for example allow the service to be adapted to the applications and/or the applications to be adapted to the service.

According to an optional feature of the invention, the communication with the plurality of applications is according to a peer to peer protocol. This may provide means of communication which is particularly suitable for ad hoc and/or dynamic group formations for service accesses.

According to an optional feature of the invention, the plurality of applications are located in different user devices. The invention may allow for group based service access from different user devices. The user devices may have different functional and logical characteristics.

According to a second aspect of the invention, there is provided an apparatus for accessing a service, the apparatus comprising: means for transmitting a group formation request to a plurality of applications, means for receiving a group join indication from at least some applications of the plurality of applications, the group join indication of each application of the at least some applications comprising application constraint data; means for determining group constraint data in response to the constraint data of each of the at least some applications; and means for accessing the service using the group constraint data.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a communication system incorporating some embodiments of the invention; and

FIG. 2 is a flow chart of a method of accessing a service in accordance with some embodiments of the invention.

### DETAILED DESCRIPTION OF EMBODIMENTS OF THE INVENTION

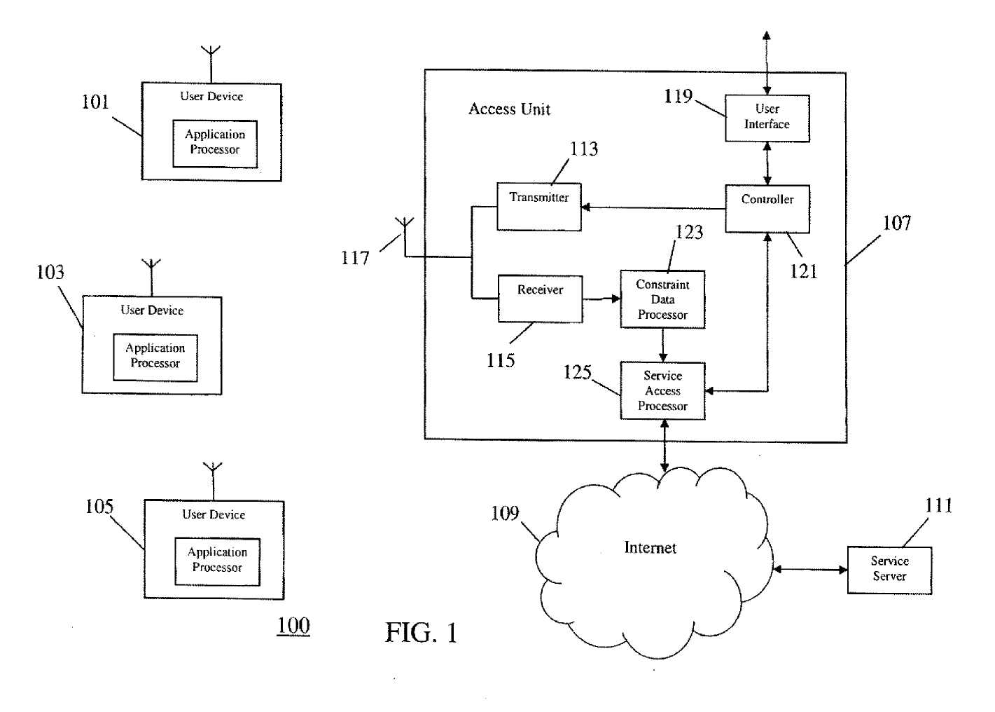

FIG. 1 illustrates a communication system incorporating embodiment(s) of the invention. In the example of FIG. 1, a plurality of user devices 101 103, 105 communicate with an access unit 107 over an adhoc wireless communication interface. The access unit wire 107 is connected the Internet 109. A service server 111 is connected to the Internet and the access unit 107 may access a service provided by the service server 111 through the Internet 109.

The user devices 101, 103, 105 comprise functionality for receiving and transmitting data over the air interface of the adhoc network. The adhoc network may for example, be an IEEE 811.b wireless data network. The wireless data network may be a proprietary or standardised wireless communication. It will be appreciated that in other embodiments, other means of communication may be used and that these communication means may include wired or wireless communication networks. For example, the communication between user devices and access units may be through the Internet or through Local Area Networks (LANS) or Wide Area Networks (WANs).

The access unit 107 comprises a transmitter 113 and a receiver 115 which are connected to an antenna 117 (for example through a duplexer (not shown)), The access unit 107 may in particular itself be a user device which in the example of FIG. 1 comprises a user interface 119. The user interface 119 provides an interface to user and may present information to the user and/or receive user input from the user.

The user interface 119 is coupled to a controller 121 which controls the operation of the access unit 107. In particular, the controller 121 may control the access unit 107 when forming a new group for supporting a group based service access of a server provided by the service server 111. For example, in some embodiments, the controller 121 may detect a user input from the user interface 119 which corresponds to an attempt to initiate a service access of the service provided by the service server 111. If the service access is suitable for group based access, the controller 121 may cause the transmitter 113 to transmit a group formation request to the user devices 101, 103, 105. When receiving the group formation request, the user devices 101, 103, 105 may decide whether to join the group or not to join the group. The user devices 101, 103, 105 which decide to join the group will then transmit a group join indication message from the user device to the access unit via the adhoc network interface.

The group join indication message of each user device 101, 103, 105 is received by the receiver 115 of the access unit 107. The group join indication messages from the user devices 101, 103, 105 comprise application constraint data. The application constraint data is passed from the receiver 115 to a constraint data processor 123. The constraint data processor 123 is coupled to a service access processor 125 which accesses the service of the service server 111 through the Internet 109. The constraint data processor 123 is operable to receive the application constraint data from the user devices 101, 103, 105 which join the group. The constraint data processor 123 then proceeds to determine group constraint data from the individual application constraint data of the individual user devices 101, 103, 105.

For example, the constraint data processor 123 may combine the application constraint data from the individual user devices 101, 103, 105 by including all constraints of the individual applications thereby generating constraint data which includes all constrains of the application constraint data.

The service access processor 125 is operable to access the service of the service server 111 using the group constraint data. Thus, the service access processor 125 may access the service based on the information which is received from all the user devices 101, 103, 105. The parameters and input data used when accessing the service may thus comprise information associated with all applications of the user devices 101, 103, 105 that join the group.

The service access processor 125 may also receive data and information from the service executing on the service server 111. This information may be fed to the controller 121 and the controller may control the transmitter 113 to transmit this service data on to the user devices 101, 30 103, 105. Thus, the access unit 107 may distribute information from the service to the individual applications.

The access unit 107 may thus act as a group access unit, which enables the formation of a group for accessing the service. In particular, the service may be a single user service designed to be accessed by a single user. The access unit 107 may combine information from a plurality of user devices 101, 103, 105 and may distribute service data from the service to the user devices 101, 103, 105. Thus, a single user service may be used with a group of applications thereby providing a group functionality despite this not being provided for when the applications and/or service were designed.

As an example, the service provided by the service server 111 may for example be an online ticket reservation service for a cinema. The service may be designed for a single user to access the reservation system to purchase tickets for films. The input to the service may comprise an indication of a time interval in which the user is available. For example, a user of the access unit 107 may enter an input to the user interface 119, indicating a preference to watch a specific film. The controller may determine that the service to be accessed is the ticket reservation service of the service server 111. In response to this detection, the controller 121 may cause the transmitter 113 to transmit group formation requests to the user devices 101, 103, 105.

Each user device 101, 103, 105 executes an application determining if the user of the user device 101, 103, 105 has a user preference for the same film. If so, the application of the user device 101, 103, 105 transmits a group join indication to the access unit 107. The group join indication comprises application constraint data indicating a time interval of availability. The constraint data processor 123 combines the time intervals received from each user device to generate a time interval in which all users joining the group are available for watching the film.

The service access processor 125 then accesses the service using the group constraint data in the form of the time interval where all users are available. The service returns a reservation confirmation indicating the time of the showing for which tickets have been obtained. The controller 121 causes the transmitter 113 to distribute this reservation confirmation to all user devices 101, 103, 105 that have joined the group.

The example illustrates how a group based service is provided from a single user based service. Thus, in the example, when the user of the access unit 107 instigates a ticket reservation action for a film, other users are automatically requested to join the group to watch the film. The users who are interested may automatically reply and a reservation is automatically made by accessing the ticket reservation system and the required booking information is automatically distributed to the users.

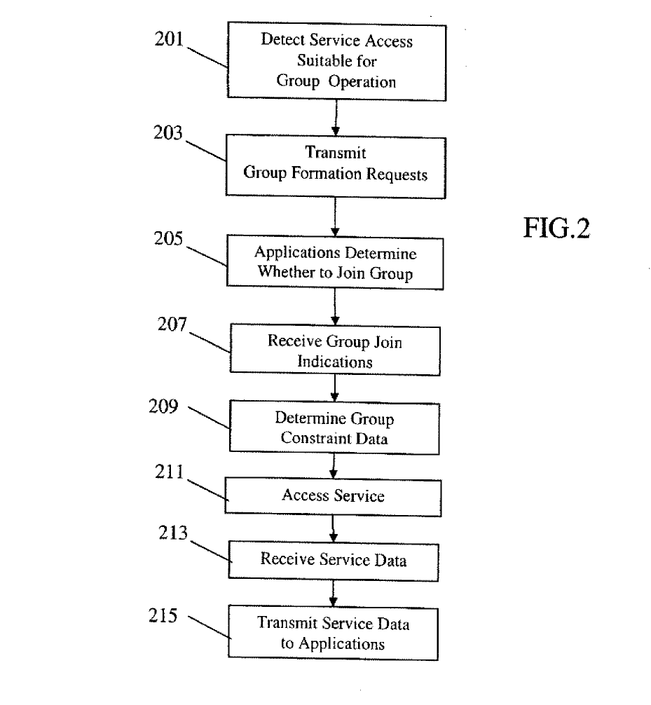

FIG. 2 illustrates a flow chart of a method of accessing a service in accordance with some embodiments of the invention. The method is applicable to the system of FIG. 1 and will be described with reference to this.

The method starts in step 201. In step 201, the controller 121 detects that a service access is being initiated. The controller 121 furthermore determines if this service access is suitable for a group based service. it will be appreciated that any suitable mechanism for detecting a suitable service access may be used. For example, the characteristic of the service being accessed may be compared to a predetermined list of services, and if a match is found, it may be determined that the service access is suitable for a group based access. In some embodiments, a suitable service may be detected in response to a previous service access. In other embodiments, a user of the access unit 107 and/or the user devices 101, 103, 105 may directly instigate a group based service access. In some embodiments, a group based service access may be instigated in response to a detection of an event or specific context for the operation of the access unit 107 and/or the user devices 101, 103, 105.

Step 201 is followed by Step 203. In step 203, the controller 121 determines a plurality of applications and user devices which will be invited to join the group. It will be appreciated that any suitable algorithm or criterion for deciding which applications and/or user devices are invited may be used. For example, a user may manually indicate a list of applications or users to be invited. Additionally or alternatively, the list of participants may be determined in response to a previous service access.

The controller 121 furthermore proceeds to cause the transmitter 113 to transmit group formation requests to the user devices 101, 103, 105. The group formation requests comprise information related to the service, and in particular comprise service data characteristics indicative of one or more inputs required for the service.

For example, the service may be an event ticket reservation service requiring an input of data which specifies one or more time intervals for the event. In such case, the group formation request may comprise an indication that the service requires an input of availability .

The group formation request may in particular specify the data structure and constraints required for the input. In some embodiments an ontology may be used for representing these data structures. As another example, the group formation request may comprise an indication of available options for a specific parameter. For example, the group formation request may indicate a list of available films at a specific cinema. The group formation request may furthermore specify one or more parameters for which constraint data from the user devices 101, 103, 105 are mandatory and/or optional.

Step 203 is followed by Step 205. In step 205, the user devices 101, 103, 105 receive the group information request from the access unit 107. The applications of the user devices 101, 103, 105 evaluate the group formation request and decide whether to join the group or not to join the group.

Step 205 is followed by Step 207. In step 207, the user devices 101, 103, 105 operating applications deciding to join the group transmit group join indication messages to the access unit 107. The access unit 107 receives the group join indications from the application. The group join indications comprise constraint data from the individual application, and this application constraint data is fed to the constraint data processor 123.

Step 207 is followed by Step 209 in which the constraint data processor 123 determines group constraint data for accessing the service. The group constraint data may, for example, comprise constraint data which includes all constrains of all applications joining the group.

Step 209 is followed by Step 211 wherein the service access processor 125 accesses the service of the service server 111. The service access processor 125 contacts the service server Ill in order to obtain the desired service. The access comprises the group constraint data which has been determined by the constraint data processor 123. In the described example, the group constraint data uses the same data format as for a single user access and the group constraint data may specifically be indistinguishable from normal single user constraint data. Accordingly, the service operates in the same way for the current group based access as it will for a single user access to the service. Accordingly, the group based service execution may be transparent to the service provider and does not require any design modifications or special functionality to be included.

Step 211 is followed by Step 213 wherein the service server 111 transmits service data through the Internet 109 to the service access processor 125. The access unit 107 thus receives the output data of the service.

Step 213 is followed by Step 215 wherein the received service data is fed to the controller 121 by which it is transmitted (using the transmitter 113) to the user devices 101, 103, 105 which have joined the group. In particular, the service data fed to the user devices 101, 103, 105 may be similar to service data provided to a single user. Thus, apart from the group formation functionality of the user devices 101, 103, 105, the same applications may be used for single user access and group based user access of services without requiring any design modifications of the applications.

The embodiment of FIG. 1 and FIG. 2 may thus provide many advantages. For example, group based access of the single user service is facilitated, enabled and/or improved. Furthermore, a more flexible and/or high performance group based service access is provided. In particular, any kind of existing application or service may be used not only as a single user service but also as a group based service taking into account the constraints of the participants.

A dynamic and flexible group formation may allow groups to be formed as and when they are needed and may allow individual applications and/or user devices and/or users to join groups when advantageous. The embodiments may allow a dynamic creation of user groups during run time based on the characteristics and features of the service being accessed as well as characteristics and features of the applications and user preferences of individual users. Consensual input for the service may be determined at run time based on current preferences and conditions of the individual applications.

It will be appreciated that the individual applications ay use any suitable algorithm or criteria for determining application constraint data. For example, the applications may determine application constraint data in response to a current context of the application or in response to user data which has been stored either in the application or by other applications. For example, a diary application may comprise information of the availability of a user and a ticket reservation application may determine a suitable time of availability in response to entries in the diary system.

In some embodiments, the application constraint data may be determined in response to a user input. For example, the application may present a user with a request for information and the user may specifically enter application constraint data directly.

In some embodiments the service has at least one associated service input. For example, the service may require a time of availability for a given event for which tickets are being reserved. In such embodiments, the group formation request may comprise an indication of a characteristic of the associated service input. The application may determine the application constraint data in response to this associated service input and user data of the application. For example, the associated service input may be an input of availability and the group formation request may comprise an indication that it is mandatory to include a time interval of availability for this service input. This may then be determined in response to user data such as for example diary information.

It will be appreciated that any suitable criterion or algorithm may be used by the constraint data processor 123 in determining the group constraint data. In particular, the constraint data processor 123 may determine group constraint data for the associated service input by combining the application constraint data for that associated service input from all user devices 101, 103, 105.

For example, if the service has a time interval data input, the application constraint data of that input from all applications may be combined to create a single time availability input. E.g., a first application may indicate a first availability interval and a second application may indicate a second availability time interval. The group constraint data for that input may simply be set to the overlapping time interval between the first and the second time interval. In such an example the group constraint data for that service input may thus be derived by determining a time interval in which all applications indicate that the respective user is available.

It will be appreciated that in many embodiments, more complex and advanced algorithms for determining group constraints may be used. For example, a more complex rule based approach for determining consensual constraint data ay be applied. As a specific example, group constraint data for a time availability may be determined as any time interval in which 80% or more of the participating applications indicate an availability. In other embodiments, applications may be treated differently and may, for example, be allocated an individual priority. In such embodiments, group constraint data for a time availability may be determined as a time interval in which all high priority applications indicate availability and a certain proportion of low priority applications indicate an availability.

In some embodiments, the controller 121 is operable to determine a group context associated with the group. For example, a group context may be defined which comprises an indication of the type of service associated with the group, a list of users or applications associated with the group, and/or a group policy used for determining group constraint data and/or for accessing the service. In particular, the group policy may specify the purpose of the group and/or it may specify rules and criteria for determining which users or applications can belong to the group.

In some embodiments, the group context may be included in the group formation request. This may allow the individual applications to decide whether to join or not to join the group in response to the group context. For example, an application may decide whether to join the group or not depending on the identity or number of other users invited to join the group or in response to the type of the service as indicated in the group context. The individual applications may furthermore adapt their operation for this specific group context and may for example determine the application constraint data in response to the group context.

In some embodiments, the plurality of applications or user devices which are invited to join the group may be determined in response to the group context. For example, in some embodiments, the group context may comprise a list of users or applications which are considered suitable for joining the group. The group formation requests may accordingly be transmitted only to the list of users or applications comprised in the group context. This may facilitate formation of a group and may reduce the loading of the communication network by reducing the number of messages transmitted It may furthermore reduce the processing required by the individual user devices, as only group formation requests related to groups for which they are likely to be interested need to be considered.

In some embodiments, the group constraint data is further determined in response to the group context. For example, the group constraint data may be determined in response to a priority of individual applications as identified by the group context. As another example, the group constraint data may be determined in response to rules or policies determined in the group context.

In some embodiments the group context is stored and retrieved when a new service access is instigated. In such embodiments, the group context may be a predetermined group context which has been manually defined either during design of the services, the applications of the user devices 101, 103, 105 and/or the applications of the access unit 107 or may have been manually entered by a user of the access unit 107 or of the user devices 101, 103, 105.

However, in some embodiments, the group context is dynamically and (semi-) automatically determined by the access unit 107 in response to user activities and service accesses. In particular, a group context may be updated by the controller 121 in response to a characteristic of an access of the service. Thus, when a service is accessed as a group based service, the controller 121 may monitor the access and determine one or more characteristics of the service access in response to this monitoring based on the measured characteristics, a new group context may be created or an existing group context may be updated.

Specifically, the access unit 107 may comprise a learning processor which is operable to monitor the operation of the access unit 107 and to update a group context in response to this operation. The learning processor may for example be operable to determine the user preferences of individual users of the user devices 101, 103, 105 and/or the access unit 107 and may determine a group preference in response to the individual user preferences.

For example, the learning processor may use the group context to determine the list of participants and it may monitor the frequency of users participating in groups for various types of service. It may then determine the group context and update the participant list of the group context accordingly.

The learning processor may generate new context stereotypes which may for example, identify the most frequently contacted people for a specific group context. As a specific example, the learning processor may identify that a user frequently goes to the cinema to watch a specific type of films with a specific group of people. Accordingly, a group context associated with that type of film may be created and the group context may comprise an identification of the users who currently go to the cinema. Accordingly, when the controller detects a user input requesting reservation of tickets for a film of the specified type, the controller may retrieve the group context and contact the applications and users comprised in the group context by transmitting a group formation request to the user devices of those users.

The user responds to the group formation request by transmitting group join indications which indicate a time of availability and the constraint data processor 123 may in response determine group constraint data which is indicative of the availability of the users intending to participate in the group. The service access processor 125 may subsequently contact the service server 111 to reserve tickets for the specified film for the users of the access unit 107 and user devices 101, 103, 105 that have joined the group.

As previously mentioned, each application may determine whether to join a group or not when receiving a group formation request message. In some embodiments, the individual application requests a user input from the user identifying whether to join the group or not. In other embodiments, the applications may automatically or semi-automatically determine whether to join the group or not. For example, in some such embodiments, the applications may decide to join the group in response to a user preference associated with the application, a service characteristic of the service and/or an input requirement of the service. For example, the application may determine if the type of service is a type which has a high preference value for the user.

In some embodiments the individual application monitors the behaviour and preferences of the individual user. In particular, the application may monitor the type of services and/or objects in which the user is interested. For example, the application may detect that a user has a preference for a certain type of film and prefers to reserve tickets for a certain day of the week and a certain time. Accordingly, the application may decide to respond positively to any group formation request relating to a film of the preferred type showing at the preferred time. In some embodiments, the application may determine whether to join the group or not in response to an input requirement of the service. For example, some input requirements of the service may not be compatible with the application and the application may therefore refrain from joining the group.

In some embodiments the service access operation is determined in response to a type of service. For example, the group context may not be determined in response to a single specific service but rather to a type of services. Thus, the same group context may be used for a plurality of services of the same type or relating to same activity. For example, a group context determined in response to service access of a ticket reservation service of a first cinema may be used for a ticket reservation at a second cinema. Service providers offering a similar or identical service may be classed together and may be used together with the same group context and the same operation.

It will be appreciated that the above description for clarity has described embodiments of the invention with reference to different functional units and processors.

However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. A method of accessing a service, the method comprising:
transmitting a group formation request to a plurality of applications;
receiving a group join indication from at least some applications of the plurality of applications, the group join indication of each application of the at least some applications comprising application constraint data;
determining group constraint data in response to the application constraint data of each of the at least some applications; and
accessing the service using the group constraint data.

2. The method claimed in claim 1 further comprising receiving service output data from the service and distributing the service output data to the at least some applications.

3 The method of claim 1 wherein the service has at least one associated service input and the group constraint data comprises constraint data for the associated service input.

4 The method of claim 1 wherein the group formation request comprises an indication of a characteristic of the associated service input.

5. The method of claim 3 further comprising the at least some applications determining the application constraint data in response to the associated service input and user data of the application.

6. The method of claim 4 wherein the determining of the group constraint data comprises determining a group constraint data value for the associated service input in response to application constraint data of the at least some applications for the associated service input

7. The method of claim 1 wherein the group constraint data is determined by combining the application constraint data of the at least some applications.

8. The method of claim 1 further comprising determining a group context associated with the service.

9. The method claimed in claim 8 wherein the group formation request comprises the group context information.

10. The method claimed in claim 8 further comprising selecting the plurality of applications in response to the group context.

11. The method claimed in claim 8 wherein the group constraint data is further determined in response to the group context.

12. The method claimed in claim 8 wherein determining the group context comprises retrieving a stored group context associated with the service.

13. The method claimed in claim 8 further comprising updating a group context in response to a characteristic of the access of the service and storing the updated group context.

14. The method claimed in claim 1 further comprising determining a service context of the service and wherein transmitting the group formation request is dependent on the service context.

15. The method claimed in claim 1 further comprising each of the plurality of applications determining whether to join the group in response to a user preference associated with the application.

16. The method claimed in claim 1 further comprising each of the plurality of applications determining whether to join the group in response to a service characteristic of the service.

17. (canceled)

18. The method claimed in claim 1 further comprising determining a group profile comprising the group constraint data, an identification of the at least some applications and an identification of the service.

19. The method claimed claim 1 wherein communication with the plurality of applications is according to a peer to peer protocol.

20. The method claimed claim 1 wherein the plurality of applications are located in different user devices.

21. (canceled)

22. (canceled)

23. An apparatus for accessing a service, the apparatus comprising:
means for transmitting a group formation request to a plurality of applications;
means for receiving a group join indication from at least some applications of the plurality of applications, the group join indication of each application of the at least some applications comprising application constraint data;
means for determining group constraint data in response to the application constraint data of each of the at least some applications; and
means for accessing the service using the group constraint data.
